(19) United States
(12) Patent Application Publication
(10) Pub. No.: US 2020/0339795 A1
(43) Pub. Date: Oct. 29, 2020

(54) Polymer Composition Comprising Recycled Polypropylene

(71) Applicant: TOTAL RESEARCH & TECHNOLOGY FELUY, Seneffe (BE)

(72) Inventors: Alain Standaert, Bruxelles (BE); Isabelle Ydens, Saint Vaast (BE); Gabriela Quevedo Silvetti, Nivelles (BE); Daniel Libert, Court-Saint-Etienne (BE); Katty Den Dauw, Woluwè-Saint-Lambert (BE)

(21) Appl. No.: 16/760,360

(22) PCT Filed: Oct. 27, 2018
(86) PCT No.: PCT/EP2018/079520

§ 371 Date: Apr. 29, 2020

(30) Foreign Application Priority Data
Oct. 31, 2017 (EP) 17199435.3

(51) Int. Cl. C08L 23/12

(52) U.S. Cl. CPC C08L 23/12; C08L 2205/03; C08L 2207/20; C08L 2207/02; C08L 2205/08

(57) ABSTRACT

The present invention relates to a polymer composition comprising:
a first polypropylene (A);
at least one ethylene vinyl acetate copolymer;
wherein said first polypropylene (A) is a recycled polypropylene comprising at most 25.0 % by weight of polyethylene based on the total weight of polypropylene (A).

The present invention also relates to an article comprising a polymer composition according to the invention and further relates to a process for making said article.

### FIELD OF THE INVENTION

The present invention relates to a polymer composition comprising recycled polypropylene, to the use of said polymer composition for the preparation of an article and to said article comprising said polymer composition.

### BACKGROUND OF THE INVENTION

Polypropylene products are used in many applications where mechanical properties are of high importance (crates, bins, boxes, trays, automotive parts, food packaging produced by injection molding, extrusion blow molding, extrusion thermoforming, etc.); relevant mechanical properties include stiffness and impact resistance. Processing and aesthetical properties are also of high importance for most converters and end-users.

The traditional method of modifying the impact resistance of polypropylene is by addition of a dispersed polymeric phase offering impact resistance; this can be achieved by extrusion blending or by copolymerization. Impact modifier polymers include elastomers, plastomers, EPR, EPDM, PBu, SEBS, LDPE, LLDPE, HDPE, . . . . The limitation of this technique is often linked to the rapid loss of stiffness and the lack of compatibility between the dispersed phase and the polypropylene matrix. Amorphous elastomers increase the impact resistance with a high efficiency but have a detrimental effect on the stiffness while semi-crystalline polymers such as polyethylene have a less detrimental effect on the stiffness but a limited effect on the impact resistance; moreover the compatibility between polypropylene and polyethylene is often an issue if the quantity or the viscosity of the polyethylene phase is too high.

Current post-consumer recycled polyolefins (i.e. rPE or rPP) contain a blend of PP's with PE's from different origins and in various amounts depending on the sorting technology.

These blends, most of the time, exhibit poor mechanical and aesthetic performances linked to the poor compatibility of one polymer into the main one. Consequently, recycled material is often dedicated to low end applications.

There is therefore a demand for polymer compositions comprising recycled polypropylene having improved mechanical properties such as stiffness, impact resistance, brittleness temperature and good processability.

It is therefore an object of the present invention to provide polymer composition comprising recycled polypropylene having improved mechanical properties.

### SUMMARY OF THE INVENTION

It has now surprisingly been found that the above objective can be attained either individually or in any combination by a polymer composition comprising the specific and well-defined polymers as disclosed herein.

Thus, in a first aspect, the present invention provides for a polymer composition comprising:
a first polypropylene (A);
at least one ethylene vinyl acetate copolymer;
wherein said first polypropylene (A) is a recycled polypropylene comprising at most 25.0% by weight of polyethylene based on the total weight of polypropylene (A).

In addition, in a second aspect, the present invention encompasses an article comprising the polymer composition according to the first aspect of the invention.

In addition, in a third aspect, the present invention encompasses a process for making an article according to the second aspect comprising the steps of preparing a polymer composition according to the first aspect of the invention and processing said polymer composition into an article.

The inventors have surprisingly found that the present compositions exhibited improved mechanical and optical properties, when compared to prior art compositions comprising recycled polypropylene. These prior art polymer compositions have poor dispersion. A poor dispersion is characterized by poor mechanical properties such as poor Falling Weight Impact property, high brittleness temperature or poor optical properties on film measured by the number and the size of gels. The present compositions exhibited improved mechanical and optical properties when compared to prior art compositions comprising recycled polypropylene.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### BRIEF DESCRIPTION OF THE FIGURES

FIG. 1 represents a ¹³C{¹H} NMR spectrum of a recycled polypropylene sample (QPC™ EXPP 152A). The spectrum was obtained by Fourier Transform on 131K points after a light Gaussian multiplication. Chemical shifts are shown at +/−0.05 ppm.

FIG. 2 represents a graph plotting the ductile failures (falling weight impact test), as a function of temperature, for compositions 1-5 and Systalen 11404.

FIG. 3 represents a graph plotting the total energy of rupture (falling weight impact test), as a function of temperature, for compositions 1-5 and Systalen 11404.

FIG. 4 represents a graph plotting the brittleness temperature (falling weight impact test), as a function of flexural modulus, for compositions 1-5 and Systalen 11404.

FIG. 5 represents a graph plotting the number of defects as measured using OCS, as a function of brittleness temperature (falling weight impact test), for compositions 1-5 and Systalen 11404.

FIG. 6 represents a graph plotting resilience (notched izod) as measured at a temperature of 23° C., as a function of flexural modulus as measured at a temperature of 23° C., for compositions 1-5 and Systalen 11404.

FIG. 7 represents a graph plotting resilience (notched izod) as measured at a temperature of −20° C., as a function of flexural modulus as measured at a temperature of 23° C., for compositions 1-5 and Systalen 11404.

### DETAILED DESCRIPTION OF THE INVENTION

When describing the invention, the terms used are to be construed in accordance with the following definitions, unless a context dictates otherwise.

As used herein, the singular forms “a”, “an”, and “the” include both singular and plural referents unless the context clearly dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

Preferred statements (features) and embodiments of the polymer compositions, articles uses and process of this invention are set herein below. Each statements and embodiments of the invention so defined may be combined with any other statement and/or embodiments unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered aspects and embodiments 1 to 38 with any other statement and/or embodiments.
1. A polymer composition comprising:
   a first polypropylene (A);
   at least one ethylene vinyl acetate copolymer;
   wherein said first polypropylene (A) is a recycled polypropylene comprising at most 25.0% by weight of polyethylene based on the total weight of polypropylene (A).
2. The polymer composition according to statement 1, wherein said first polypropylene (A) is a post-consumer recycled polypropylene (PCR-PP), or a mixture of post-consumer recycled polypropylene and post-industrial recycled polypropylene (PIR-PP).
3. The polymer composition according to any one of statements 1 or 2, wherein said first polypropylene (A) comprises preferably at most 24.0% by weight of polyethylene based on the total weight of polypropylene (A), for example at most 23.0% by weight, preferably at most 22.0% by weight, preferably at most 21.0% by weight, preferably at most 20.0% by weight, preferably at most 19.0% by weight, preferably at most 18.0% by weight, for example at most 16.0% by weight, preferably at most 15.0% by weight, preferably at most 13.0% by weight, preferably at most 11.0% by weight, preferably at most 9.0% by weight, preferably at most 7.0% by weight, for example at most 6.0% by weight, based on the total weight of polypropylene (A).
4. The polymer composition according to any one of statements 1 to 3, wherein said first polypropylene (A) comprises preferably at least 1.0% by weight of polyethylene based on the total weight of polypropylene (A), for example at least 1.1% by weight, preferably at least 1.2% by weight, preferably at least 1.3% by weight of polyethylene based on the total weight of polypropylene (A).
5. The polymer composition according to any one of statements 1 to 4, wherein said first polypropylene (A) comprises from 1.0% to 25.0% by weight of polyethylene based on the total weight of polypropylene (A), preferably from 1.1% to 25.0% by weight, preferably from 1.0% to 20.0% by weight, preferably from 1.1% to 15.0% by weight, preferably from 1.1% to 13.0% by weight, preferably from 1.2% to 11.0% by weight, preferably from 1.2% to 9.0% by weight, for example from 1.3% to 6.0% by weight of polyethylene based on the total weight of polypropylene (A).
6. The polymer composition according to any one of statements 1 to 5, wherein said polyethylene has a high load melt index (HLMI) of at most 30 g/10 min, preferably at most 29.0 g/10 min, preferably at most 28.0 g/10 min, preferably at most 27.0 g/10 min, preferably at most 26.0 g/10 min, preferably at most 25.0 g/10 min as determined by ISO 1133 condition G, at 190° C. and under a load of 21.6 kg.
7. The polymer composition according to any one of statements 1 to 6, wherein said polymer composition comprises at least 10.0% by weight, of said first polypropylene (A) based on the total weight of the polymer composition, preferably at least 15.0% by weight, preferably at least 17.0% by weight, preferably at least 20.0% by weight, preferably at least 25.0% by weight of said first polypropylene (A) based on the total weight of the polymer composition.
8. The polymer composition according to any one of statements 1 to 7, wherein said polymer composition comprises at most 99.9% by weight, of said first polypropylene (A) based on the total weight of the polymer composition, preferably at most 95.0% by weight, preferably at most 90.0% by weight, preferably at most 85.0% by weight, preferably 75.0% by weight of said first polypropylene (A) based on the total weight of the polymer composition.
9. The polymer composition according to any one of statements 1 to 8, wherein said polymer composition comprises from 10.0% to 99.9% by weight of said first polypropylene (A), preferably from 13.0% to 99.9% by weight, preferably from 15.0% to 99.9% by weight, preferably from 17.0% to 99.9% by weight, preferably from 19.0% to 99.9% by weight, for example from 21.0% to 99.0% by weight, for example from 23.0% to 99.0% by weight, for example from 25.0% to 99.0% of said first polypropylene (A) based on the total weight of the polymer composition
10. The polymer composition according to any one of statements 1 to 9, wherein said polymer composition comprises at least 0.1% by weight of said at least one ethylene vinyl acetate copolymer, preferably at least 0.5% by weight, preferably at least 1.0% by weight, based on the total weight of the polymer composition.
11. The polymer composition according to any one of statements 1 to 10, wherein said polymer composition comprises from 0.1% to 5.0% by weight of said at least one ethylene vinyl acetate copolymer, preferably from 0.5% to 5.0% by weight, preferably 1.0% to 5.0% by weight, preferably from 1.0% to 4.0% by weight, preferably from 1.0% to 3.5% by weight based on the total weight of the polymer composition.
12. The polymer composition according to any one of statements 1 to 11, wherein said ethylene vinyl acetate copolymer has a melt flow rate MI superior to 0.1 g/10 min as determined according to ISO 1133, condition D, at 190° C. and under a load of 2.16 kg, preferably at least 0.4 g/10 min, preferably at least 0.5 g/10 min, for example at least 0.5 g/10 min to at most 9 g/10 min, for example at least 0.5 g/10 min to at most 8 g/10 min, for example at least 0.5 g/10 min to at most 7 g/10 min, for example at least 0.5 g/10 min to at most 6 g/10 min, for example at least 0.5 g/10 min to at most 5 g/10 min, for example at least 0.5 g/10 min to at most 4.5 g/10 min.
13. The polymer composition according to any one of statements 1 to 12, wherein said ethylene vinyl acetate copolymer has a vinyl acetate content of at least 4.0% by weight, preferably of at least 4.5% by weight, preferably of at least 5.0% by weight, preferably of at least 5.5% by weight, preferably of at least 6.0% by weight, preferably of at least 6.5% by weight, preferably of at least 7.0% by weight, preferably at most 20.0% by weight based on the total weight of the ethylene vinyl acetate copolymer, as determined by ¹H-NMR analysis.
14. The polymer composition according to any one of statements 1 to 13, wherein said polymer composition comprises a second polypropylene (B), preferably wherein said second polypropylene (B) is virgin polypropylene.
15. The polymer composition according to any one of statements 1 to 14, wherein said polymer composition comprises a second polypropylene (B), wherein said second polypropylene (B) is virgin polypropylene and preferably wherein said virgin polypropylene (B) is a propylene copolymer, preferably said polypropylene is a copolymer of propylene with one or more comonomers selected from ethylene and a C4 to C12 olefin, preferably said polypropylene is a copolymer of propylene with ethylene as comonomer.
16. The polymer composition according to any one of statements 1 to 15, wherein said polymer composition comprises a second polypropylene (B), wherein said second polypropylene (B) is virgin polypropylene and wherein said second polypropylene (B) is a heterophasic propylene copolymer, preferably said polypropylene is a heterophasic copolymer of propylene with one or more comonomers selected from ethylene and a C4 to C12 olefin, preferably wherein said polypropylene is a heterophasic copolymer of propylene with ethylene as comonomer.
17. The polymer composition according to any one of statements 1 to 16, wherein said polymer composition comprises at least 1.0 by weight of a second polypropylene (B) based on the total weight of the polymer composition, for example at least 2.0% by weight, for example at least 5.0% by weight of a second polypropylene (B) based on the total weight of the polymer composition, wherein said second polypropylene (B) is virgin polypropylene, preferably wherein said polymer composition comprises at least 10.0% by weight, preferably at least 15.0% by weight, preferably at least 20.0% by weight, preferably at least 25.0% by weight of said second polypropylene (B) based on the total weight of the polymer composition
18. The polymer composition according to any one of statements 1 to 17, wherein said polymer composition comprises at most 90.0% by weight of a second polypropylene (B) based on the total weight of the polymer composition, preferably wherein said second polypropylene (B) is virgin polypropylene, preferably wherein said polymer composition comprises at most 89.9% by weight, preferably at most 83.0% by weight, preferably at most 80.0% by weight, preferably at most 77.0% by weight, preferably at most 75.0% by weight of said second polypropylene (B) based on the total weight of the polymer composition.
19. The polymer composition according to any one of statements 1 to 18, wherein said composition comprises a second polypropylene (B), wherein said second polypropylene (B) has a melt flow index determined according to ISO 1133, condition M at 230° C. and under a load of 2.16 kg of at least 0.3 g/10 min, preferably of at least 0.5 g/10 min, preferably of at least 1.0 g/10 min, preferably of at least 2.0 g/10 min, preferably of at least 3.0 g/10 min, preferably of at least 3.5 g/10 min, preferably of at least 4.0 g/10 min, preferably of at least 4.5 g/10 min, preferably of at least 5.0 g/10 min.
20. The polymer composition according to any one of statements 1 to 19, wherein said composition comprises a second polypropylene (B), wherein said second polypropylene (B) has a melt flow index determined according to ISO 1133, condition M at 230° C. and under a load of 2.16 kg of at most 150 g/10 min, preferably of at most 125 g/10 min, preferably of at most 100.0 g/10 min, preferably of at most 75.0 g/10 min, preferably of at most 60.0 g/10 min, preferably of at most 50.0 g/10 min, preferably of at most 40.0 g/10 min, preferably of at most 30 g/10 min, preferably of at most 25.0 g/10 min.
21. The polymer composition according to any one of statements 1 to 20, wherein said composition comprises a second polypropylene (B), wherein said second polypropylene (B) has a melt flow index determined according to ISO 1133, condition M at 230° C. and under a load of 2.16 kg from at least 0.3 g/10 min to at most 150 g/10 min, preferably from at least 0.5 g/10 min to at most 125 g/10 min, preferably from at least 1.0 g/10 min to at most 100.0 g/10 min, preferably from at least 2.0 g/10 min to at most 75.0 g/10 min, preferably from at least 3.0 g/10 min to at most 60.0 g/10 min, preferably from at least 3.5 g/10 min to at most 50.0 g/10 min, preferably from at least 4.0 g/10 min to at most 40.0 g/10 min, preferably from at least 4.5 g/10 min to at most 30 g/10 min, preferably from at least 5.0 g/10 min to at most 25.0 g/10 min.
22. The polymer composition according to any one of statements 1 to 21, wherein said polymer composition comprises one or more nucleating agents.
23. The polymer composition according to any one of statements 1 to 22, wherein said polymer composition comprises at most 20.0% by weight, preferably at most 19.0% by weight, preferably at most 18.0% by weight, preferably at most 17.0% by weight, preferably at most 15.0% by weight of one or more nucleating agents based on the total weight of the polymer composition.
24. The polymer composition according to any one of statements 1 to 23, wherein said polymer composition comprises at least 0.01% by weight, preferably at least 0.02% by weight, preferably at least 0.03% by weight, preferably at least 0.04% by weight, preferably at least 0.05% by weight, preferably at least 0.07% by weight, preferably at least 0.08% by weight, preferably at least 0.09% by weight, preferably at least 1.0% by weight of one or more nucleating agents based on the total weight of the polymer composition.
25. The polymer composition according to any one of statements 1 to 24, wherein said polymer composition comprises from 0.01% to 20.0% by weight, preferably from 0.02% to 20.0% by weight, preferably from 0.03% to 19.0% by weight, preferably from 0.04% to 19.0% by weight, preferably from 0.05% to 18.0% by weight, preferably from 0.06% to 18.0% by weight, preferably from 0.07% to 17.0% by weight, preferably from 0.08% to 17.0% by weight, preferably from 0.09% to 16.0% by weight, preferably from 1.0% to 15.0% by weight of one or more nucleating agents based on the total weight of the polymer composition.
26. The polymer composition according to any one of statements 1 to 25, wherein said polymer composition comprises
   from 10.0% to 99.9% by weight of said first polypropylene (A), preferably from 13.0% to 99.9% by weight, preferably from 15.0% to 99.9% by weight, preferably from 17.0% to 99.9% by weight, preferably from 19.0% to 99.9% by weight, for example from 21.0% to 99.0% by weight, for example from 23.0% to 99.0% by weight, for example from 25.0% to 99.0% by weight of said first polypropylene (A) based on the total weight of the polymer composition;
   from 0.1% to 5.0% by weight of said at least one ethylene vinyl acetate copolymer, preferably from 0.5% to 5.0% by weight, preferably from 1.0% to 5.0% by weight, preferably from 1.0% to 4.0% by weight, preferably from 1.0% to 3.5% by weight based on the total weight of the polymer composition;
   from 0.0% to 90.0% by weight of a second polypropylene (B) based on the total weight of the polymer composition, and wherein said second polypropylene B is virgin polypropylene, preferably from 0.0% to 89.9% by weight, preferably from 0.0% to 83.0% by weight, preferably from 0.0% to 80.0% by weight, preferably from 0.0% to 77.0% by weight, preferably from 0.0% to 75.0% by weight of the second polypropylene (B) based on the total weight of the polymer composition; and
   from 0.0% to 20.0% by weight of said one or more nucleating agents based on the total weight of the polymer composition, preferably from 0.0% to 19% by weight, preferably from 0.0% to 18% by weight, preferably from 0.0% to 17% by weight, preferably from 0.0% to 16% by weight, preferably from 0.0% to 15% by weight based on the total weight of the polymer composition.
27. The polymer composition according to any one of statements 1 to 26, wherein said polymer composition comprises
   from 10.0% to 99.9% by weight of said first polypropylene (A), preferably from 13.0% to 99.9% by weight, preferably from 15.0% to 99.9% by weight, preferably from 17.0% to 99.9% by weight, preferably from 19.0% to 99.9% by weight, for example from 21.0% to 99.0% by weight, for example from 23.0% to 99.0% by weight, for example from 25.0% to 99.0% of said first polypropylene (A) based on the total weight of the polymer composition;
   from 0.1% to 5.0% by weight of said at least one ethylene vinyl acetate copolymer, preferably from 0.5% to 5.0% by weight, preferably from 1.0% to 5.0% by weight, preferably from 1.0% to 4.0% by weight, preferably from 1.0% to 3.5% by weight based on the total weight of the polymer composition;
   from 5.0% to 90.0% by weight of a second polypropylene (B), wherein said second polypropylene B is virgin polypropylene, preferably from 5.0% to 89.9% by weight, preferably from 10.0% to 83.0% by weight, preferably from 15.0% to 80.0% by weight, preferably from 20.0% to 77.0% by weight, preferably from 25.0% to 75.0% by weight of the second polypropylene (B) based on the total weight of the polymer composition; and
   from 0.0% to 20.0% by weight of said one or more nucleating agents, preferably from 0.01% to 20.0% by weight, preferably from 0.02% to 20.0% by weight, preferably from 0.03% to 19.0% by weight, preferably from 0.04% to 19.0% by weight, preferably from 0.05% to 18.0% by weight, preferably from 0.06% to 18.0% by weight, preferably from 0.07% to 17.0% by weight, preferably from 0.08% to 17.0% by weight, preferably from 0.09% to 16.0% by weight, preferably from 1.0% to 15.0% by weight based on the total weight of the polymer composition.
28. The polymer composition according to any one of statements 1 to 27, wherein said polymer composition comprises one or more nucleating agents selected from the group consisting of talc, phosphate ester salts, carboxylate salts, sorbitol acetals, substituted benzene tricarboxamides and polymeric nucleating agents, as well as blends thereof.
29. The polymer composition according to any one of statements 1 to 28, wherein said polymer composition comprises at least two different nucleating agents.
30. The polymer composition according to any one of statements 1 to 29, wherein said polymer composition comprises a total amount of at most 99.9% by weight of a first polypropylene (A) and an optional second polypropylene (B) which is preferably a virgin polypropylene, preferably at most 99.5% by weight, preferably at most 99.0% by weight, preferably at most 98.5% by weight, preferably at most 98.0% by weight based on the total weight of the polymer composition.
31. The polymer composition according to any one of statements 1 to 30, wherein the amount of polyethylene in said recycled polypropylene (A) is determined by DSC analysis.
32. The polymer composition according to any one of statements 1 to 31, wherein the amount of polyethylene in said recycled polypropylene (A) is determined by ¹³C{¹H}NMR analysis.
33. An article comprising a polymer composition according to any one of statements 1 to 32.
34. The article according to statement 33, wherein said article is an extruded article.
35. The article according to statements 34 or 35, wherein said article is an injected article.
36. A process for preparing an article according to any one of statements 33 to 35 comprising the steps of preparing a polymer composition according to any one of statements 1 to 32 and processing said polymer composition into an article.
37. The process according to statement 36 comprising the steps of
   a) blending, preferably melt blending:
      a first polypropylene (A) which is a recycled polypropylene comprising at most 25.0% by weight of polyethylene based on the total weight of polypropylene (A);
      at least one ethylene vinyl acetate copolymer; and
      optionally a second polypropylene (B), which preferably is a virgin polypropylene;
      optionally one or more nucleating agents;
   (b) extruding the blend,
   (c) processing the extruded blend into an article.
38. The process according to any one of statements 36 or 37, wherein said processing step comprises using one or more polymer processing techniques selected from injection molding; pipe and fiber extrusion or coextrusion; film and sheet extrusion or co-extrusion, blow molding; rotational molding; foaming; and thermoforming.

According to the present invention, the present polymer composition comprises a first polypropylene (A). For the purposes of the present application, the term “polypropylene” is used to denote propylene homopolymer as well as propylene copolymers. If the propylene is a copolymer, the comonomer can be any alpha-olefin i.e. any C2 to C12 alpha-alkylene.

The polypropylene can be atactic, isotactic or syndiotactic polypropylene. The copolymer can be either a random or heterophasic copolymer.

Said first polyprolylene (A) is a recycled or reclaimed polypropylene. For the purposes of the present application, the term “recycled polypropylene” or “reclaimed polypropylene” is synonymous and is used to describe polymeric material identified by a material re-processor that has been extruded after initial processing by the original material manufacturer. The recycled polypropylene may come from post-consumer sources, or from a mixture of post-industrial and post-consumer sources, preferably rigid food and consumer packaging. A source of recycled polypropylene suitable for the present application is blow moulded bottles, film, syringe cases, intravenous bags, tubing, and tubing fittings. Preferably, “recycled” PP encompasses post-consumer recycled (PCR) PP, or a mixture of PCR-PP and post-industrial recycled (PIR) PP.

In some embodiments said first polypropylene (A) is a post-consumer recycled polypropylene.

Preferably the polymer composition comprises at least 10.0% by weight, of said first polypropylene (A) based on the total weight of the polymer composition, preferably at least 12.0% by weight, preferably at least 15.0% by weight, preferably at least 18.0% by weight, preferably at least 20.0% by weight of said first polypropylene (A) based on the total weight of the polymer composition.

Preferably the polymer composition comprises from 10.0% to 99.9% by weight of said first polypropylene (A), preferably from 12.0% to 99.9% by weight, preferably from 14.0% to 99.9% by weight, preferably from 16.0% to 99.9% by weight, preferably from 18.0% to 99.9% by weight, for example from 20.0% to 99.0% by weight, for example from 22.0% to 99.0% by weight, for example from 25.0% to 99.0% of said first polypropylene (A) based on the total weight of the polymer composition.

The first polypropylene (A) (i.e. the recycled polypropylene) suitable for the present invention comprises polyethylene. For the purposes of the present application, the term “polyethylene” is used to denote ethylene homopolymer as well as ethylene copolymers. If the polyethylene is a copolymer, the comonomer can be any alpha-olefin i.e. any alpha-alkylene comprising from 3 to 12 carbon atoms, for example, propylene, 1-butene, and 1-hexene.

Said first polypropylene (A) comprises at most 25.0% by weight of polyethylene based on the total weight of polypropylene (A), preferably at most 20.0% by weight, preferably at most 15.0% by weight, preferably at most 13.0% by weight, preferably at most 11.0% by weight, preferably at most 9.0% by weight, preferably at most 7.0% by weight, for example at most 6.0% by weight, preferably at least 1.0% by weight of polyethylene based on the total weight of polypropylene (A).

The polymer composition also comprises at least one ethylene vinyl acetate copolymer (EVA) such as, e.g., polyethylene-co-vinyl acetate.

In some embodiments, said polymer composition comprises from 0.1% to 5.0% by weight of said at least one ethylene vinyl acetate copolymer based on the total weight of the polymer composition. Preferably, the polymer composition comprises from 0.3% to 5.0% by weight of said at least one ethylene vinyl acetate copolymer based on the total weight of the polymer composition, preferably from 0.4% to 5.0% by weight, preferably from 1.0% to 4.5% by weight, preferably from 1.0% to 4.3% by weight, preferably from 1.0% to 3.8% by weight.

In some embodiments, said ethylene vinyl acetate copolymer has a melt flow rate MI at least 0.2 g/10 min as determined according to ISO 1133, condition D, at 190° C. and under a load of 2.16 kg, preferably at least 0.3 g/10 min, preferably at least 0.5 g/10 min, for example at least 0.5 g/10 min to at most 9 g/10 min, for example at least 0.5 g/10 min to at most 8 g/10 min, for example at least 0.1 g/10 min to at most 7 g/10 min, for example at least 0.1 g/10 min to at most 6 g/10 min, for example at least 0.1 g/10 min to at most 5 g/10 min, for example at least 0.1 g/10 min to at most 4.5 g/10 min.

In an embodiment, said ethylene vinyl acetate copolymer has a vinyl acetate content of at least 4.5% by weight, preferably of at least 5.2% by weight, preferably of at least 5.7% by weight, preferably of at least 6.5% by weight, preferably of at least 7.5% by weight, preferably of at least 8.5% by weight, preferably of at least 9.5% by weight, preferably of at least 10.5% by weight, preferably at most 20.0% by weight based on the total weight of the ethylene vinyl acetate copolymer, as determined by ¹H-NMR analysis.

Examples of suitable EVA polymers include products under the name EVA 1020 VN5 commercially available from TOTAL Refining and Chemicals, product under the name Elvax™, produced by DuPont, or Evatane™ produced by Arkema. Other suitable EVA polymers are commercially available from Versalis, Exxon, and Repsol.

According to some embodiments, the present polymer composition also optionally comprises a second polypropylene (B), preferably said second polypropylene is virgin polypropylene.

As used herein, “virgin polypropylene” refers to polypropylene that has not been recycled, either industrially or through the consumer waste stream. Virgin propylene is a term to describe a polypropylene that has not been used in a manufacturing process of a plastic product or has otherwise been recycled or reclaimed.

For the purposes of the present application, the term “polypropylene” is used to denote propylene homopolymer as well as propylene copolymers. If the propylene is a copolymer, the comonomer can be any alpha-olefin i.e. any C2 to C12 alpha-alkylene. The polypropylene can be atactic, isotactic or syndiotactic polypropylene. The copolymer can be either a random or heterophasic copolymer.

In some embodiments, the second polypropylene (B) for use in the present polymer composition is a propylene copolymer, more preferably a copolymer of propylene with one or more comonomers selected from ethylene and a C4 to C12 olefin.

In some embodiments, the second polypropylene (B) for use in the present polymer composition is a propylene heterophasic copolymer or a propylene random copolymer.

Preferably said second propylene copolymer (B) can be present in the polymer composition in an amount of at least 1.0% by weight based on the total weight of the polymer composition, preferably at least 5.0% by weight based on the total weight of the polymer composition, preferably at least 10.0% by weight, preferably at least 15.0% by weight, preferably at least 20.0% by weight, preferably at least 25.0% by weight.

More preferably, the second polypropylene (B) is a heterophasic propylene copolymer, preferably a heterophasic copolymer of propylene with one or more comonomers selected from ethylene and a C4 to C12 olefin. Preferred comonomers are ethylene, 1-butene, 1-pentene, 1-hexene, and 1-octene. More preferred comonomers are ethylene and 1-butene. The most preferred comonomer is ethylene.

Generally, a heterophasic polypropylene is a propylene copolymer comprising a propylene homo or random copolymer matrix component (1) and an elastomeric copolymer component (2) of propylene with one or more of ethylene and C4-C12 olefin comonomers, wherein the elastomeric (amorphous) copolymer component (2) is dispersed in said propylene homo or random copolymer matrix polymer (1). Accordingly, the heterophasic copolymer of propylene as used herein means that the elastomeric (amorphous) propylene copolymer component (=elastomeric component) is (finely) dispersed in the polypropylene matrix component.

Preferably said heterophasic propylene copolymer (B) can be present in the polymer composition in an amount at least 1.0% by weight based on the total weight of the polymer composition, preferably at least 5.0% by weight based on the total weight of the polymer composition, preferably at least 10.0% by weight, preferably at least 15.0% by weight, preferably at least 20.0% by weight, preferably at least 25.0% by weight.

In some embodiment, the polypropylene (B) which can be used in the polymer composition can have a melt flow index determined according to ISO 1133, condition M at 230° C. and under a load of 2.16 kg of at least 0.3 g/10 min, preferably of at least 0.8 g/10 min, preferably of at least 1.1 g/10 min, preferably of at least 2.5 g/10 min, preferably of at least 3.2 g/10 min, preferably of at least 3.5 g/10 min, preferably of at least 4.2 g/10 min, preferably of at least 4.5 g/10 min, preferably of at least 5.0 g/10 min.

In some embodiment, the polypropylene (B) which can be used in the polymer composition can have a melt flow index determined according to ISO 1133, condition M at 230° C. and under a load of 2.16 kg of at most 150 g/10 min, preferably of at most 130 g/10 min, preferably of at most 110.0 g/10 min, preferably of at most 85.0 g/10 min, preferably of at most 70.0 g/10 min, preferably of at most 55.0 g/10 min, preferably of at most 45.0 g/10 min, preferably of at most 35 g/10 min, preferably of at most 25.0 g/10 min.

According to some embodiments, the present polymer composition can also comprise one or more nucleating agents.

Preferably the polymer composition can comprise from 0.0% to 20.0% by weight of said one or more nucleating agents based on the total weight of the polymer composition, preferably from 0.02% to 20.0% by weight, preferably from 0.02% to 19.0% by weight, preferably from 0.03% to 20.0% by weight, preferably from 0.04% to 20.0% by weight, preferably from 0.05% to 19.0% by weight, preferably from 0.06% to 19.0% by weight, preferably from 0.07% to 18.0% by weight, preferably from 0.08% to 18.0% by weight, preferably from 0.09% to 15.0% by weight, preferably from 1.0% to 17.0% by weight based on the total weight of the polymer composition.

The nucleating agents which can be used in the present invention can be any of the nucleating agents known to the skilled person. It is, however, preferred that the nucleating agent be selected from the group consisting of talc, carboxylate salts, sorbitol acetals, phosphate ester salts, substituted benzene tricarboxamides and polymeric nucleating agents, as well as blends of these.

Examples of suitable carboxylate salts include organocarboxylic acid salts. Particular examples are sodium benzoate, lithium benzoate and cyclohexane-1,2-dicarboxylic acid salt, which is sold as HYPERFORM® HPN-20 by Milliken Chemical. The organocarboxylic acid salts may also be alicyclic organocarboxylic acid salts, such as bicyclic organodicarboxylic acid salts and in particular bicyclo[2.2.1]heptane dicarboxylic acid salt. A nucleating agent of this type is sold as HYPERFORM® HPN-68 by Milliken Chemical. Examples of suitable sorbitol acetals include dibenzylidene sorbitol (DBS), bis(p-methyl-dibenzylidene sorbitol) (MDBS), bis(p-ethyl-dibenzylidene sorbitol), bis(3,4-dimethyl-dibenzylidene sorbitol) (DMDBS), and bis(4-propylbenzylidene) propyl sorbitol. Bis(3,4-dimethyl-dibenzylidene sorbitol) (DMDBS) and bis(4-propylbenzylidene) propyl sorbitol are preferred. These can for example be obtained from Milliken Chemical under the trade names of Millad 3905, Millad 3940, Millad 3988 and Millad NX8000. Examples of suitable phosphate ester salts include salts of 2,2′-methylene-bis-(4,6-di-tert-butylphenyl)phosphate. Such phosphate ester salts are for example available as NA-11 or NA-21 from Asahi Denka.

Examples of suitable substituted tricarboxamides include compounds of general formula (III):

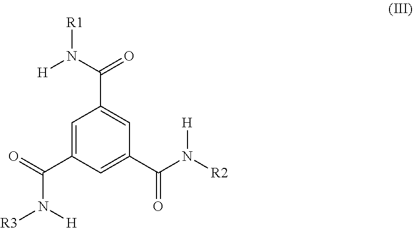

wherein, in compounds of formula (III), R1, R2 and R3, independently of one another, are selected from C₁-C₂₀ alkyl, C₁-C₁₂ cycloalkyl, or phenyl, each of which may in turn be substituted with one or more C₁-C₂₀ alkyl, C₁-C₁₂ cycloalkyl, phenyl, hydroxyl, C1-C₂₀ alkylamino or C₁-C₂₀ alkyloxy etc. Examples of C₁-C₂₀ alkyl include methyl, ethyl, n-propyl, n-butyl, iso-butyl, tert-butyl, n-pentyl, iso-pentyl, 1,1-dimethylpropyl, 1,2-dimethylpropyl, 3-methylbutyl, hexyl, heptyl, octyl or 1,1,3,3-tetramethylbutyl. Examples of C₅-C₁₂ cycloalkyl include cyclopentyl, cyclohexyl, cyclooctyl, cyclododecyl, adamantyl, 2-methylcyclohexyl, 3-methylcyclohexyl or 2,3-dimethylcyclohexyl. Such nucleating agents are disclosed in WO 03/102069 and by Blomenhofer et al. in Macromolecules 2005, 38, 3688-3695. Non-limiting examples of polymeric nucleating agents include polymeric nucleating agents containing vinyl compounds, such as for example those disclosed in EP-A1-0152701 and EP-A2-0368577. Polymeric nucleating agents containing vinyl compounds can either be physically or chemically blended with the polypropylene. Suitable vinyl compounds include vinyl cycloalkanes or vinyl cycloalkenes having at least 6 carbon atoms, such as for example vinyl cyclopentane, vinyl-3-methyl cyclopentane, vinyl cyclohexane, vinyl-2-methyl cyclohexane, vinyl-3-methyl cyclohexane, vinyl norbornane, vinyl cyclopentene, vinyl cyclohexene, vinyl-2-methyl cyclohexene. Further examples of polymeric nucleating agents include poly-3-methyl-1-butene, polydimethylstyrene, polysilanes and polyalkylxylenes. These polymeric nucleating agents can be introduced into the polypropylene either by chemical or by physical blending.

Other nucleating agents useful in the embodiments disclosed herein may include various organic and inorganic nucleating agents, such as: the gamma-crystalline form of a quinacridone colorant Permanent Red E3B “Q-Dye;” the disodium salt of o-phthalic acid; the aluminum salt of 6-quinizarin sulfonic acid; isophthalic and terephthalic acids; N′,N′-dicyclohexyl-2,6-naphthalene dicarboxamide, also known as NJStar NU-100, available from the New Japan Chemical Co.; nucleating agents based upon salts of rosin/adiebetic acid; zinc (II) monoglycerolate; nucleating agents based upon diamide compounds as disclosed in U.S. Pat. No. 6,235,823, such as N-cyclohexyl-4-(N-cyclohexylcarbonylamino)benzamide and N,N′-1,4-cyclohexane-bis-benzamide, for example; nucleating agents based upon trimesic acid derivatives, such as disclosed in WO 02/46300, WO 03/102069, WO 2004/072168, including, for example, 1,3,5-benzenetricarboxylic acid tris(cyclopentylamide), 1,3,5-benzenetricarboxylic acid tris(cyclohexylamide), and 1,3,5-benzenetricarboxylic acid tris(tert-butyl)amide.

The nucleating agents may be used in the form of powders, pellets, liquids, other commonly available forms, or combinations thereof, for admixture (melt blending) with polypropylenes. In other embodiments, the nucleating agent may be compounded with a polypropylene to form a nucleating additive master batch for admixture (melt blending) with polypropylenes. Compositions including polypropylene(s) and nucleating agent(s) according to the embodiments disclosed herein may be prepared by mixing or kneading the respective components at a temperature around or above the melting point temperature of one or more of the blend components. Typical polymer mixing or kneading equipment that is capable of reaching the desired temperatures and melt plastifying the mixture may be employed.

These include mills, kneaders, extruders (both single screw and twin-screw), BANBURY® mixers, calenders, and the like. The sequence of mixing and methods may depend on the final composition as well as the form of the starting components (powder, pellet, masterbatch, etc.).

In some embodiments, the present polymer composition can comprise at least two different nucleating agents.

In some embodiments, the polymer composition comprises
from 15.0% to 99.5% by weight of said recycled polypropylene (A), preferably from 17.0% to 99.9% by weight, preferably from 19.0% to 99.9% by weight, for example from 21.0% to 99.0% by weight, for example from 23.0% to 99.0% by weight, for example from 25.0% to 99.0% of said recycled polypropylene (A) based on the total weight of the polymer composition;
from 0.1% to 5.0% by weight of said at least one ethylene vinyl acetate copolymer, preferably from 0.5% to 5.0% by weight, preferably from 1.0% to 5.0% by weight, preferably from 1.0% to 4.0% by weight, preferably from 1.0% to 3.5% by weight based on the total weight of the polymer composition;
from 0.0% to 85.0% by weight of the virgin polypropylene (B) based on the total weight of the polymer composition, preferably from 0.0% to 83.0% by weight, preferably from 0.0% to 80.0% by weight, preferably from 0.0% to 77.0% by weight, preferably from 0.0% to 75.0% by weight, for example from 1.0% to 85.0% by weight, for example from 1.0% to 83.0% by weight, for example from 1.0% to 80.0% by weight, for example from 1.0% to 77.0% by weight, for example from 1.0% to 75.0% by weight, for example from 3.0% to 85.0% by weight, for example from 3.0% to 83.0% by weight, for example from 3.0% to 80.0% by weight, for example from 3.0% to 77.0% by weight, for example from 3.0% to 75.0% by weight, for example from 5.0% to 85.0% by weight, for example from 5.0% to 83.0% by weight, for example from 5.0% to 80.0% by weight, for example from 5.0% to 77.0% by weight, for example from 5.0% to 75.0% by weight of the virgin polypropylene (B); and
from 0.0% to 5.0% by weight of one or more nucleating agents, preferably from 0.0% to 4.5% by weight, preferably from 0.0% to 4.0% by weight, preferably from 0.0% to 3.5% by weight based on the total weight of the polymer composition.

In some embodiments, the polymer composition comprises
from 15.0% to 99.9% by weight of said recycled polypropylene (A), preferably from 17.0% to 99.9% by weight, preferably from 19.0% to 99.9% by weight, for example from 21.0% to 99.0% by weight, for example from 23.0% to 99.0% by weight, for example from 25.0% to 99.0% by weight of said recycled polypropylene (A) based on the total weight of the polymer composition;
from 0.1% to 5.0% by weight of said at least one ethylene vinyl acetate copolymer, preferably from 0.5% to 5.0% by weight, preferably from 1.0% to 5.0% by weight, preferably from 1.0% to 4.0% by weight, preferably from 1.0% to 3.5% by weight based on the total weight of the polymer composition;
from 5.0% to 85.0% by weight of the virgin polypropylene (B) based on the total weight of the polymer composition, preferably from 10.0% to 83.0% by weight, preferably from 15.0% to 80.0% by weight, preferably from 20.0% to 77.0% by weight, preferably from 25.0% to 75.0% by weight of the virgin polypropylene (B); and
from 0.1% to 5.0% by weight of one or more nucleating agents, preferably from 0.5% to 5.0% by weight, preferably from 1.0% to 5.0% by weight, preferably from 1.0% to 4.0% by weight, preferably from 1.0% to 3.5% by weight based on the total weight of the polymer composition.

In some embodiments, the polymer composition comprises
from 15.0% to 99.9% by weight of said recycled polypropylene (A), preferably from 17.0% to 99.9% by weight, preferably from 19.0% to 99.5% by weight, for example from 20.0% to 99.0% by weight, for example from 23.0% to 99.0% by weight, for example from 25.0% to 99.0% of said recycled polypropylene (A) based on the total weight of the polymer composition;
from 0.1% to 5.0% by weight of said at least one ethylene vinyl acetate copolymer, preferably from 0.5% to 5.0% by weight, preferably from 1.0% to 5.0% by weight, preferably from 1.0% to 4.0% by weight, preferably from 1.0% to 3.5% by weight based on the total weight of the polymer composition;
from 5.0% to 85.0% by weight of the virgin polypropylene (B) based on the total weight of the polymer composition, preferably a propylene copolymer, more preferably a heterophasic propylene copolymer based on the total weight of the polymer composition, preferably from 10.0% to 83.0% by weight, preferably from 15.0% to 80.0% by weight, preferably from 20.0% to 77.0% by weight, preferably from 25.0% to 75.0% by weight of the virgin polypropylene (B); and
from 0.1% to 5.0% by weight of one or more nucleating agents, preferably from 0.5% to 5.0% by weight, preferably from 1.0% to 5.0% by weight, preferably from 1.0% to 4.0% by weight, preferably from 1.0% to 3.5% by weight based on the total weight of the polymer composition.

The polymer composition may further contain additives, such as, by way of example, processing aids, mould-release agents, primary and secondary antioxidants, acid scavengers, flame retardants, fillers, nanocomposites, lubricants, antistatic additives, nucleating/clarifying agents, antibacterial agents, plastisizers, colorants/pigments/dyes and mixtures thereof. Illustrative pigments or colorants include titanium dioxide, carbon black, cobalt aluminum oxides such as cobalt blue, and chromium oxides such as chromium oxide green. Pigments such as ultramarine blue, phthalocyanine blue and iron oxide red are also suitable. These additives may be included in amounts effective to impart the desired properties.

An overview of the additives that can be used may be found in Plastics Additives Handbook, ed. H. Zweifel, 5th edition, 2001, Hanser Publishers.

The present invention also encompasses an article comprising a polymer composition according to the invention.

The present invention also encompasses a process for preparing an article, comprising the steps preparing a polymer composition according to the invention and processing said polymer composition into an article.

Preferably, the process comprises the steps of
a) blending, preferably melt blending:
   a first polypropylene (A), which is a recycled polypropylene comprising at most 25.0% by weight of polyethylene based on the total weight of polypropylene (A);
   at least one ethylene vinyl acetate copolymer;
   optionally a second polypropylene (B) which is a virgin polypropylene; and
   optionally one or more nucleating agents;
(b) extruding the blend,
(c) processing the extruded blend into an article.

Preferably, said processing step comprises using one or more polymer processing techniques selected from injection molding; pipe and fiber extrusion or coextrusion; film and sheet extrusion or co-extrusion, blow molding; rotational molding; foaming; and thermoforming.

The blending of the components of the polymer composition can be carried out according to any physical blending method and combinations thereof known in the art. This can be, for instance, dry blending, wet blending or melt blending. The blending conditions depend upon the blending technique involved.

If dry blending is employed, the dry blending conditions may include temperatures from room temperature up to just under the lowest melting temperature of the polymers employed. The components can be dry blended prior to a melt blending stage, which can take place for example in an extruder. Melt processing is fast and simple and makes use of standard equipment of the thermoplastics industry. The components can be melt blended in a batch process such as in a Brabender Internal Mixer, Banbury, Haake or Clextral extruder or in a continuous process, such as in an extruder e.g. a single or twin screw extruder. During melt blending, the temperature at which the polymers are combined in the blender will generally be in the range between the highest melting point of the polymers employed and up to about 90° C. above such melting point, preferably between such melting point and up to 50° C. above it. The time required for the melt blending can vary broadly and depends on the method of blending employed. The time required is the time sufficient to thoroughly mix the components.

The polymer compositions are useful in applications known to one skilled in the art, such as forming operations (e.g., film, sheet, pipe and fiber extrusion and co-extrusion as well as blow molding, injection molding and rotational molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, pipes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example, Molded articles include single and multi-layered constructions in the form of bottles, tanks, large hollow articles, rigid food containers, crates and toys, for example.

The present invention can allow:
Compatibilizing of recycled polypropylene stream contaminated with polyethylene
Improving the impact resistance, improving the brittleness temperature
Reducing gels in blown film and cast film made of recycled polypropylene compositions
Reducing gels in Extrusion Thermoforming
Improving melt strength in Blow Molding of polyethylene or polypropylene or polyethylene/polypropylene blends
Reducing gels of Automotive polypropylene compounds
Reducing gels in injection molding

The invention will now be illustrated by the following, non-limiting illustrations of particular embodiments of the invention.

### EXAMPLES

The Melt Index

The melt flow rate of polypropylene was measured according to ISO 1133:1997, condition M, at 230° C. and under a load of 2.16 kg.

The melt flow rate of the composition (blend) was measured according to ISO 1133:1997, condition M, at 230° C. and under a load of 2.16 kg.

VA Content in EVA

The ¹H-NMR analysis was performed using a 500 MHz Bruker NMR spectrometer with a high temperature 5 mm probe under conditions such that the signal intensity in the spectrum is directly proportional to the total number of contributing hydrogen atoms in the sample. Such conditions are well known to the skilled person and include for example sufficient relaxation time etc. In practice, the intensity of a signal is obtained from its integral, i.e. the corresponding area. The data were acquired using 32 scans per spectrum, a pulse repetition delay of 10 seconds and a spectral width of 15 ppm at a temperature of 130° C. The sample was prepared by dissolving a sufficient amount of polymer in 1,2,4-trichlorobenzene (TCB, 99%, spectroscopic grade) at 130° C. and occasional agitation to homogenize the sample, followed by the addition of hexadeuterobenzene (CD, spectroscopic grade) and a minor amount of hexamethyldisiloxane (HMDS, 99.5+%), with HMDS serving as internal standard. To give an example, about 60 mg of polymer were dissolved in 0.5 ml of TCB, followed by addition of 0.25 ml of CDs and 1 drop of HMDS.

Following data acquisition, the chemical shifts are referenced to the signal of the internal standard HMDS, which is assigned a value of δ 0.055 ppm. The VA content was determined by ¹H-NMR analysis on the total polymer. The different chemical shifts can be found below in Table 1 and were assigned using published data.

TABLE 1

| Sort of Hydrogen | Chemical shifts (ppm) |
|---|---|
| 1H mono | 7.2 |
| CHO VA + 1H mono | 5.2-4.56 |
| 1H mono | 4.5 |
| CH₃ VA | 2.1-1.9 |
| 4E + 5VA + 3H mono | 2.6-0.5 |

The following normalized areas are defined to estimate the VA content:

Mono area=(H mono 7.2 ppm+H mono 4.5 ppm)/2

VA area=(CHO VA+1H mono area)−mono area

E area=((4E+5VA+3H mono)area−5 VA area−3 mono area)/4

The VA content is then calculated according to the following equation

VA content (% weight)=VA area*8600/(mono area*86+VA area*86+E area*28)

Flexural Modulus

The flexural modulus was determined according to ISO 178:2011 method A with the conditions listed in Table 2.

TABLE 2

| Temperature | 23° C. |
|---|---|
| Test machine | 00-0311 (Zwick tensile testing machine) |
| Force sensor | 200N cell |
| Displacement transducer | Extensometer |
| Norm | ISO-178:2011 method A |
| Test specimen | bar 80 mm × 10 mm × 4 mm cut from type |
| | 1A specimen |
| Pre-charge | 0.5N |
| Test speed | 2 mm/min |
| Span between specimen | 64 mm |
| supports | |
| End of the test | 1.5% |
| Relative humidity | 50% ± 10% |

Tensile Modulus Properties

Tensile properties were measured according to ISO 527-1A with the conditions listed in Table 3.

TABLE 3

| Temperature | 23° C. |
|---|---|
| Test machine | 00-0311 (Zwick tensile testing machine) |
| Force sensor | 10 kN |
| Displacement transducer | Extensometer |
| Norm | ISO-527:2012 |
| Test specimen | type 1A |
| Pre-charge | 5N |
| Modulus speed | 1 mm/min |
| Test speed | 50 mm/min |
| Thickness average | 4.07 mm |
| Average width | 10.05 mm |
| Relative humidity | 50% ± 10% |

Falling Weight Impact Test

The falling weight test on 60×60×2 mm plaques was performed according to ISO 6603-2:2002 with the following conditions: The tests were done on a Fractovis Ceast equipment with a hammer M2091 having a diameter of 12.7 mm and a weight of 19.927 kg. The hammer was not lubricated. The test speed was 4.43 m/s. the number of points was 15000. The frequency was 1333 kHz. An internal digital trigger was used. Test specimens were in the form injection-molded plates and had the following dimensions 60×60×2 mm. The diameter of the sample holder was 40 mm. The tests were carried out at a temperature of −30° C., −20° C., −10° C., 0° C., 4° C., 10° C., 15° C., 23° C., and 30° C. The height was 1.0 m and the impact energy was 195.44 J. The results are based upon an average of 5 samples.

Ductility index (DI) (%)=((Energy at break−Energy at Peak)/Energy at break)×100

Default classification: (≤10: Fragile, >10 and ≤35: intermediate, >35: Ductile)

Gels Content

Polymer pellets were extruded into a film. The gels were counted using an Optical control systems (OCS®) (www.ocsgmbh.com), which comprised an extruder of the type ME connected to a cast film unit which is connected to a Film Surface Analyzer FSA100 from Optical Control Systems. Film thickness was 70 μm.

Notched Izod

Notched Izod was performed according to ISO 180:2001, V notch sample type 1A, with the conditions listed in Table 4. Izod impact is defined as the kinetic energy needed to initiate a fracture in a polymer sample specimen and continue the fracture until the specimen is broken. Tests of the Izod impact strength determine the resistance of a polymer sample to breakage by flexural shock as indicated by the energy expended from a pendulum type hammer in breaking a standard specimen in a single blow. The specimen is notched which serves to concentrate the stress and promote a brittle rather than ductile fracture. Specifically, the Izod impact test measures the amount of energy lost by the pendulum during the breakage of the test specimen. The energy lost by the pendulum is the sum of the energies required to initiate sample fracture, to propagate the fracture across the specimen, and any other energy loss associated with the measurement system (e.g., friction in the pendulum bearing, pendulum arm vibration, sample toss energy, etc.).

TABLE 4

| | |
|---|---|
| Temperature | 23° C. and −20° C. |
| Norm | ISO 180:2001 |
| Impact energy | 1.00 J |
| Notch type | V-Notch Type 1A |
| Test specimen | bar 80 mm × 10 mm × 4 mm cut from type 1A |
| | specimen |

Injection Molding Conditions

The test specimens for Flexural Modulus, Izod, Falling Weight and Tensile properties determination were prepared by injection molding.

Test specimens type 1A (Flexion, Izod, Traction): norm ISO 294-1:1998
Cycle time=60 s
Injection: pressure=1200 bar, time=1.9 s
Holding: pressure=280 bar, time=40 s
Temperature profile=180° C. to 200° C.
Mold temperature=30° C.
Cooling time=14.5 s

Test specimens type D2 (Falling weight): norm ISO 294-3:1998 plaques
Cycle time=60 s
Injection: pressure=1200 bar, time=0.6 s
Holding: pressure=575 bar, time=40 s
Temperature profile=180 to 200° C.
Mold temperature=30° C.
Cooling time=15.5 s

DSC Method for Measuring the Polyethylene Content in Recycled Polypropylene

Differential Scanning Calorimetry (DSC) analyses were performed in a Perkin-Elmer Pyris Diamond differential scanning calorimeter calibrated with indium as standard. The specimen was heated from 25 to 240° C. at a rate of 20° C./min, under N₂, followed by an isothermal at 240° C. for 3 min, and a subsequent cooling scan to 25° C. at a rate of 20° C./min. And then were reheated to 240° C. at 20° C./min. Polyethylene (PE) melt peak can be differentiated from polypropylene melt peak, and the amount of PE present can be determined by integration of the corresponding peak.

NMR Method for Calculating Polyethylene Content in Recycled Polypropylene

The amount of polyethylene in the polymeric part of the rPP samples was determined from the ¹³C{¹H} NMR spectrum. The sample (QPC™ EXPP 152A Polypropylene (PP—mix homopolymer/copolymer) having CAS no: 9003-07-0/9010-79-1, commercially available from QCP B.V. Polymeerstraat 1, 6161 RE Geleen—The Netherlands, and having a MFR (230° C., 2.16 kg) of 15 g/10 min, containing about 19% of PE by weight as determined by DSC) was prepared by dissolving a sufficient amount of polymer in 1,2,4-trichlorobenzene (TCB 99% spectroscopic grade) at 130° C. with occasional agitations to homogenize the sample, then followed by the addition of hexadeuterobenzene (C₆D₆, spectroscopic grade) and a minor amount of hexamethyldisiloxane (HMDS, 99.5+%), with HMDS serving as internal standard. Typically, about 200 to 300 mg of rPP were dissolved in 2.0 ml of TCB, followed by the addition of 0.5 ml of C₆D₆ and 2 to 3 drops of HMDS.

¹³C{¹H} NMR signal was recorded on a Bruker 400 or 500 MHz with a 10 mm probe under the following conditions:

Pulse angle: 90°

Pulse repetition time: 30 s

Spectral width: 25000 Hz centered at 95 ppm

Data points: 64K

Temperature: 130° C.+/−2° C.

Rotation: 15 Hz

Scan numbers: 2000-4000

Decoupling sequence: inverse-gated decoupling sequence to avoid NOE effect

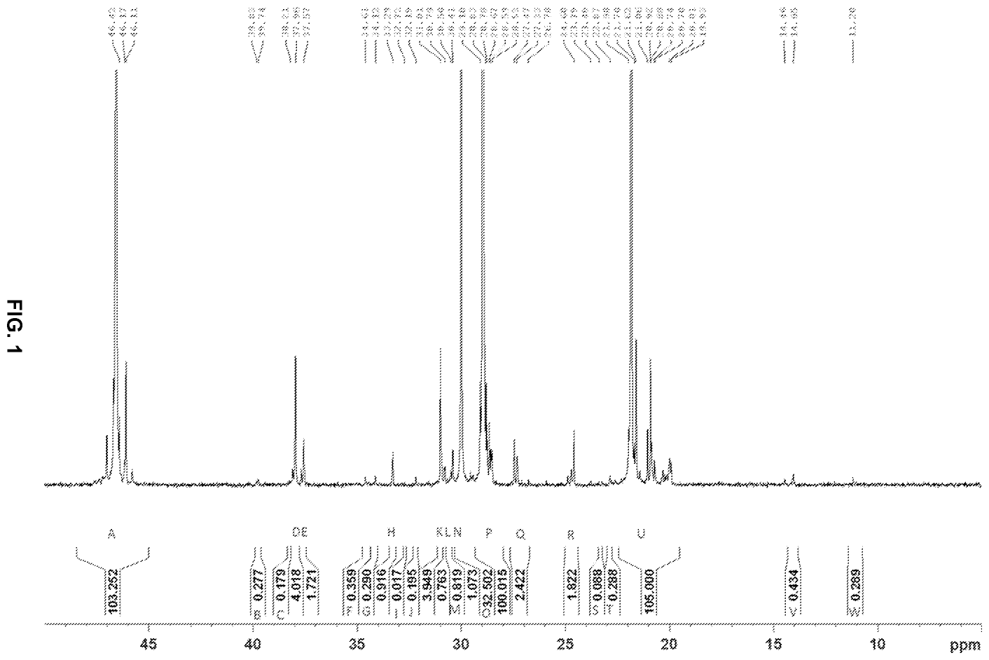

The ¹³C{¹H} NMR spectrum of the above-described sample was obtained by Fourier Transform on 131K points after a light Gaussian multiplication. The spectrum was phased, baseline corrected and chemical shift scale was referenced to the internal standard HMDS at 2.03 ppm. Chemical shifts of signals were peak picked and peaks were integrated as shown on FIG. 1; the resulting integration regions are shown in Table 5.

TABLE 5

| Region | Shift (ppm) |
|---|---|
| A | 48.5-45 |
| B | 39.92-39.64 |
| C | 38.38-38.17 |
| D | 38.17-37.8 |
| E | 37.8-37.4 |
| F | 34.8-34.38 |
| G | 34.32-34.02 |
| H | 33.5-33.1 |
| I | 32.8-32.6 |
| J | 32.3-32.1 |
| K | 31.15-30.89 |
| L | 30.89-30.73 |
| M | 30.73-30.45 |
| N | 30.5-30.34 |
| O | 30.3-29.3 |
| P | 29.3-28 |
| Q | 27.7-26.7 |
| R | 25-24.5 |
| S | 23.5-23.25 |
| T | 23-22.8 |
| U | 22.3-19.5 |
| V | 14.3-13.88 |
| W | 11.38-10.74 |

Chemical shifts are shown at +/−0.05 ppm.

The peaks in the ¹³C{¹H} NMR spectrum (FIG. 1) were be interpreted as follows:
The main peaks A, P, U are indicative of the polypropylene matrix.
Peaks D, E, H, K, L, N, O, Q, R are indicative of ethylene incorporation in polypropylene matrix.
The peak O at 30.03 ppm is indicative of (CH₂)ₙ enchainment which can be attributed to polyethylene (PE) or block sequences in polypropylene-ethylene copolymers. If there is no peak at 30.03 ppm in the spectrum of the sample, it is possible to conclude the absence of PE in the sample.
The peaks B, C, F, G, I, J, M, Q, S, T, V, W are indicative of PE branching.
Peaks O and Q are common to ethylene-propylene copolymers and PE.

The weight % of PE in the sample was then calculated from the peak areas (A) as determined form the ¹³C{¹H} NMR spectrum (see FIG. 1) as follows:

A₃=A_{U}

A₄=(A_{B}+A_{W})/2

A₆=A_{S}

A₇=A_{I}

A₈=A_{T}

A₂=(sum(A_{A} . . . A_{W})−3*A₃−4*A₄−6*A₅−7*A₇−8*A₃)/2

A′_{O}=3*A_{E}=approximation to estimate the contribution of C2PP in A_{O}

A_{C2PP}=(A_{R}+A_{E}+A_{L}+A_{N}+A′_{O}+0.5*(A_{D}+A_{E}))/2

A_{C2PE}=A₂−A_{C2PP}

X₃=A₃*42/(A₃*42+A₄*56+A₆*84+A₇*98+A₈*112+A₂*28)*100

X₄=A₄*56/(A₃*42+A₄*56+A₆*84+A₇*98+A₈*112+A₂*28)*100

X₆=A₆*84/(A₃*42+A₄*56+A₆*84+A₇*98+A₈*112+A₂*28)*100

X₇=A₇*98/(A₃*42+A₄*56+A₆*84+A₇*98+A₈*112+A₂*28)*100

X₈=A₈*112/(A₃*42+A₄*56+A₆*84+A₇*98+A₈*112+A₂*28)*100

X_{C2PE}=A_{C2PE}*28/(A₃*42+A₄*56+A₆*84+A₇*98+A₈*112+A₂*28)*100

% (wt.) PE=X₄+X₆+X₇+X₈+X_{C2PE}

Negative value of % (wt.) PE can be calculated using the above method, in this case, the % (wt.) PE present in the sample has to be considered as 0.

The above described method, allows determining the amount of polyethylene (such as high-density polyethylene (HDPE), medium-density polyethylene (MDPE), low-density polyethylene (LDPE), linear low-density polyethylene (LLDPE)) mixed with polypropylene polymers such as propylene homopolymer (PH), polypropylene random copolymer (PPR), or polypropylene copolymer (PPC), and with mixtures of PPH, PPR, and PPC (such as rPP).

A series of samples were prepared using different types of polypropylene: PPH, PPC, PPR, with varying amounts of HDPE or LDPE. The amount of PE present in each sample was determined using the ¹³C{¹H} NMR method described herein, and the results were compared with a sample of recycled polypropylene (rPP). The results can be observed in Table 6.

TABLE 6

| | | | 50% LDPE | | | | |
|---|---|---|---|---|---|---|---|
| % (wt) added PE | 10% HDPE | 20% HDPE | 1700MN18 | rPP 718450 | No added | No added | No added |
| in PP blend | 6081 | 6081 | C | EXPP152A | PE | PE | PE |
| % (w) PPH7060 | 30 | 60 | 50 | | | | 100 (*) |
| % (w) PPC7642 | 30 | 10 | | | 100 | | |
| % (w) PPR7220 | 30 | 10 | | | | 100 | |
| Total blend % | 100 | 100 | 100 | 100 | 100 | 100 | 100 |
| Estimation of | 11 | 21 | 49 | 9 | 0 | 1 | 0 |
| % (wt) PE by NMR | | | | | | | |
| Delta | +1 | +1 | −1 | | 0 | +1 | 0 |

(*) 100% PPH, A_{O} forced to 0 because of the absence of peak at 30.03 ppm

The thus calculated PE content is an estimation within +/−2 absolute weight percent maximum.

### Example 1

In this example, the following components were used:

Polypropylene Systalen 11404 is a commercial post-consumer recycled PP (rPP) resin with a density of 0.92 g/cm³ (ISO 1183-1), commercially available from Systec Plastics Eisfeld GmbH. The DSC analyses of this rPP indicate the presence of about 5.0% by weight of polyethylene based on the total weight of rPP.

EVA 1020 VN 5 is a commercial ethylene vinyl acetate copolymer with a melt flow rate of 2 g/10 min as determined according to ISO 1133 (190° C., 2.16 kg), with a VA content of 17.5%, a melting temperature of 87° C. (ISO 11357-3:2013) and a density of 0.940 g/cm³ (ISO 1183-2:2005) commercially available from TOTAL Refining and Chemicals.

Polypropylene PPC 6742 is a commercial high impact heterophasic copolymer with a melt flow rate of 8 g/10 min as determined according to ISO 1133 (230° C., 2.16 kg), and a density of 0.905 g/cm³ (ISO 1183-1), commercially available from TOTAL Refining and Chemicals.

ADK STAB NA-11 UH is a commercial nucleating agent having the following structure

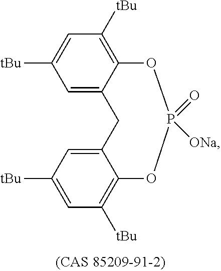

commercially available from Asahi Denka.

Talc HTP-1C is a commercial talc in powder form commercially available from IMI Fabi S.p.A., comprising as main constituent about 98% of talc (CAS 14807-96-6), 1% of chlorite (CAS 1318-59-8), about 0.5% dolomite (CAS 16389-88-1) and about 0.5% magnesite (CAS 546-93-0).

Different compositions were produced. The components of the compositions are shown in Table 7. Unless otherwise stated the amounts are given in weight % (wt. %), based on the total weight of the composition.

TABLE 7

| | Systalen | 1020V | PPC | Talc | ADK STAB |
|---|---|---|---|---|---|
| | 11404 | N5 | 6742 | HTP-1C | NA-11 |
| | wt. % | wt. % | wt. % | wt. % | ppm |
| Systalen 11404 | 100 | | | | |
| Composition 1 according | 98 | 2 | | | |
| to the invention | | | | | |
| Comparative | 69 | | 30 | 1 | 150 |
| composition 2 | | | | | |
| Composition 3 according | 67 | 2 | 30 | 1 | 150 |
| to the invention | | | | | |
| Comparative | 29 | | 70 | 1 | 150 |
| composition 4 | | | | | |
| Composition 5 according | 27 | 2 | 70 | 1 | 150 |
| to the invention | | | | | |

Compositions 1, 3 and 5 according to the invention and comparative compositions 2 and 4 were extruded on Brabender 20/40 extruder with a screen pack of 80 μm, using the following conditions:
Twin screw co-rotating, 20 mm screw diameter, =40
Screw speed=200 rpm
Temperature profile=180/190/190/190/190/190° C.

In each case, the pressure increase on the filter reached more than 100 bar quite quickly showing the presence of a lot of contaminations.

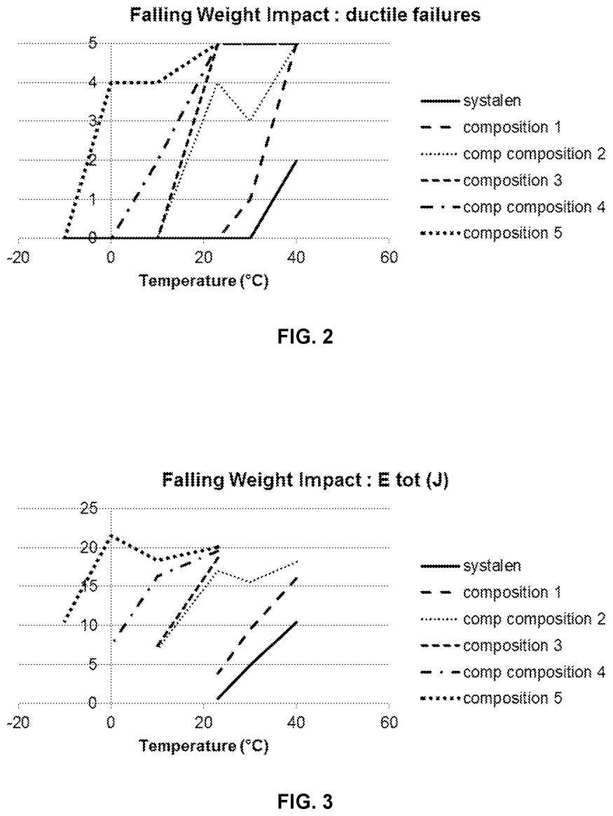

The properties of the samples prepared with the compositions were measured. The results are shown in Table 8 and FIGS. 2, 3, 4, 6, and 7.

| | | | Composition 1 | | Composition 3 | | Composition 5 |
|---|---|---|---|---|---|---|---|
| | | | according to the | Comparative | according to the | Comparative | according to the |
| | | Systalen 11404 | invention | composition 2 | invention | composition 4 | invention |
| MFI 230° C./2.16 kg | g/10 min | 9.57 | 9.91 | 9.63 | 9.24 | 9.56 | 8.52 |
| Tensile Modulus | MPa | 1223 | 1177 | 1258 | 1230 | 1275 | 1241 |
| Yield stress | MPa | 28.48 | 27.55 | 26.83 | 26.15 | 25.06 | 24.35 |
| Elongation yield | % | 10.14 | 10.84 | 7.62 | 7.73 | 5.65 | 5.79 |
| Stress break | MPa | 8.04 | 6.95 | 14.29 | 13.84 | 17 | 17.42 |
| Elongation break | % | 52.7 | 217.9 | 23.2 | 25.8 | 26.6 | 29.1 |
| Izod 23° C. | kJ/m² | 6.88 | 6.71 | 8.96 | 8.57 | 13.11 | 17.46 |
| Izod −20° C. | kJ/m² | 3.15 | 3.07 | 4.25 | 3.98 | 4.84 | 5.17 |
| FW 40° C. Energy m | J | 6.74 | 9.12 | 10.34 | | | |
| FW 40° C. Energy tot | J | 10.42 | 16.06 | 18.15 | | | |
| FW 40° C. duct | % | 35.3 | 43.2 | 43.0 | | | |
| Ductile ruptures | | 2/5 | 5/5 | 5/5 | | | |
| FW 30° C. Energy m | J | 4.76 | 6.92 | 10.52 | | | |
| FW 30° C. Energy tot | J | 4.97 | 9.51 | 15.58 | | | |
| FW 30° C. duct | % | 4.2 | 27.2 | 32.5 | | | |
| Ductile ruptures | | 0/5 | 1/5 | 3/5 | | | |
| FW 23° C. Energy m | J | 0.6 | 3.7 | 11.89 | 12.24 | 12.85 | 12.83 |
| FW 23° C. Energy tot | J | 0.62 | 3.83 | 17 | 18.64 | 19.55 | 20.04 |
| FW 23° C. duct | % | 3.2 | 3.4 | 30.1 | 34.3 | 34.3 | 36.0 |
| Ductile ruptures | | 0/5 | 0/5 | 4/5 | 5/5 | 5/5 | 5/5 |
| FW 10° C. Energy m | J | | | 6.75 | 7.26 | 13.21 | 12.99 |
| FW 10° C. Etot | J | | | 6.95 | 7.47 | 16.38 | 18.35 |
| FW 10° C. duct | % | | | 2.9 | 2.8 | 19.4 | 29.2 |
| Ductile ruptures | | | | 0/5 | 0/5 | 2/5 | 4/5 |
| FW 0° C. Energy m | J | | | | | 7.33 | 14.55 |
| FW 0° C. Energy tot | J | | | | | 7.55 | 21.54 |
| FW 0° C. duct | % | | | | | 2.9 | 32.5 |
| Ductile ruptures | | | | | | 0/5 | 4/5 |
| FW −10° C. Energy m | J | | | | | | 10.24 |
| FW −10° C. Energy tot | J | | | | | | 10.68 |
| FW −10° C. duct | % | | | | | | 4.1 |
| Ductile ruptures | | | | | | | 0/5 |
| OCS | gels/m² | 32715 | 12727 | 7439 | 7123 | 1898 | 1571 |
| | ppm | 3185 | 911 | 508 | 483 | 106 | 995* |

*influenced by a few very large gels >2500 μ which are not visible on the OCS films.

FIG. 2 shows the effect of the addition of EVA on the Falling Weight Impact. This property is sensitive to rubber content and homogeneity of the heterophasic structure. By measuring the number of ductile failures, out of 5 samples, this test reveals easily any improvement of the polymer by a decrease of the brittleness temperature, meaning the transition between 5 ductile failures and no ductile failure. This test has also the advantage to be very close to real impact conditions on the molded products. Food packaging articles stored in the fridge at 4° C. require a brittleness temperature of maximum 0° C., ideally −10° C.

FIG. 2 shows the evolution of the number of ductile failures for each composition. Surprisingly, the compositions according to an embodiment of the invention, comprising EVA have lower brittleness temperature than its counterpart without EVA. This effect is even observed at high loading of polypropylene. Clearly the presence of badly homogenized post-consumer recycled PP resin in the comparative examples has a detrimental effect on the falling weight impact, the pure post-consumer recycled PP resin being already very bad at room temperature, making it a low value polymer on the market.

FIG. 3 shows the total energy of rupture for all formulations at various temperatures. Post-consumer recycled PP resin impact properties are clearly improved by the addition of EVA. The origin of the poor properties of the post-consumer recycled PP resin is linked to the presence of polyethylene contaminating the stream; its viscosity may be too high to be well mixed with the polypropylene matrix. The addition of EVA helped the dispersion of the polyethylene into the EPR nodules.

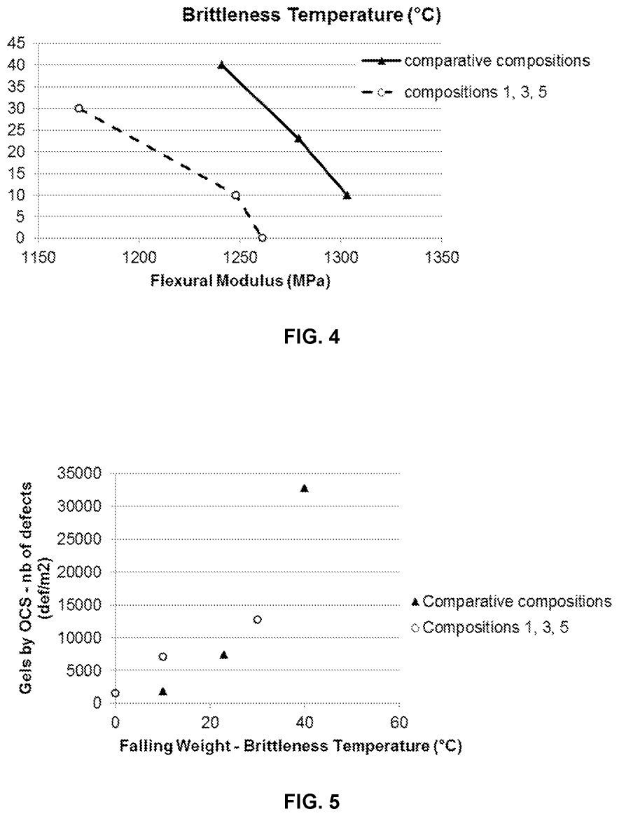

Another way to show the improvement brought by the addition of EVA is shown on FIG. 4. The addition of EVA moves the property trend to lower stiffness but significantly improved impact properties as measured by the brittleness temperature.

Another sign of homogenization can be measured with the number of gels by OCS. As shown on FIG. 5, there is a significant improvement on the number of defects observed in the post-consumer recycled PP resin, although the extrusion with EVA may have brought an additional mixing as the reference post-consumer recycled PP resin was tested without additional extrusion. This is not the case of the formulations boosted with PPC. All formulations were extruded in parallel and the effect of EVA can be evidenced easily. A slight improvement of the gels count with the addition of EVA in parallel to an improvement of the brittleness temperature can be observed.

The addition of EVA improves significantly the properties of a post-consumer recycled PP resin contaminated by polyethylene. This improvement is measured by a better brittleness temperature (better falling weight impact at low temperature) and lower gels. Even when the post-consumer recycled PP resin is combined with 30 or 70% of pure polypropylene, the improvement is still visible.

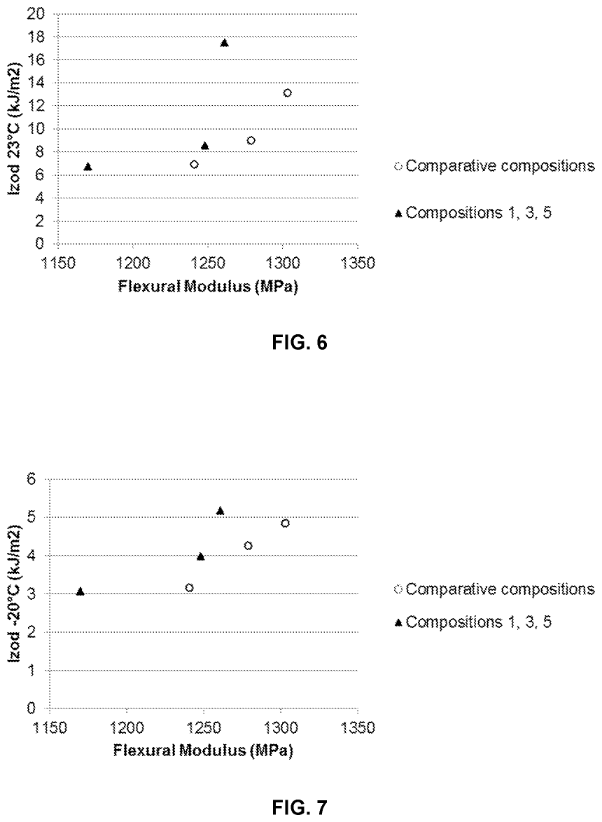

FIG. 6 shows the flexural modulus as a function of the Resilience (Izod at 23° C.) for each of the composition tested. FIG. 7 shows the flexural modulus as a function of the Resilience (Izod at −20° C.) for each of the composition tested.

1.-15. (canceled)

16. A polymer composition comprising:
a first polypropylene (A);
at least one ethylene vinyl acetate copolymer;
wherein the first polypropylene (A) is a recycled polypropylene comprising at most 25.0% by weight of polyethylene based on the total weight of polypropylene (A).

17. The polymer composition according to claim 16, wherein the first polypropylene (A) is a post-consumer recycled polypropylene (PCR-PP), or a mixture of post-consumer recycled polypropylene and post-industrial recycled polypropylene (PIR-PP).

18. The polymer composition according to claim 16, wherein the first polypropylene (A) comprises at most 20.0% by weight of polyethylene based on the total weight of polypropylene (A).

19. The polymer composition according to claim 16, wherein the polymer composition comprises from 10.0% to 99.9% by weight of the first polypropylene (A) based on the total weight of the polymer composition

20. The polymer composition according to claim 16, wherein the polymer composition comprises from 0.1% to 5.0% by weight of the at least one ethylene vinyl acetate copolymer based on the total weight of the polymer composition

21. The polymer composition according to claim 16, wherein the at least one ethylene vinyl acetate copolymer has a melt flow rate MI superior to 0.1 g/10 min as determined according to ISO 1133, condition D, at 190° C. and under a load of 2.16 kg.

22. The polymer composition according to claim 16, wherein the polymer composition comprises a second polypropylene (B), wherein the second polypropylene is virgin polypropylene.

23. The polymer composition according to claim 16, wherein the polymer composition comprises at least 5.0% by weight of a second polypropylene (B) based on the total weight of the polymer composition, wherein the second polypropylene is virgin polypropylene.

24. The polymer composition according to claim 16, wherein the polymer composition comprises one or more nucleating agents.

25. The polymer composition according to claim 16, wherein the polymer composition comprises from 0.01% to 20.0% by weight of one or more nucleating agents based on the total weight of the polymer composition.

26. The polymer composition according to claim 16, wherein the polymer composition comprises one or more nucleating agents selected from the group consisting of talc, phosphate ester salts, carboxylate salts, sorbitol acetals, substituted benzene tricarboxamides and polymeric nucleating agents, as well as blends thereof.

27. The polymer composition according to claim 16, wherein the polymer composition comprises a total amount of at most 99.9% by weight of first polypropylene (A) and optional second polypropylene (B), based on the total weight of the polymer composition

28. An article comprising a polymer composition according to claim 16.

29. The article according to claim 28, wherein the article is an injected or extruded article.

30. A process for making an article according to claim 28 comprising the steps of preparing a polymer composition comprising:
a first polypropylene (A);
at least one ethylene vinyl acetate copolymer;
wherein the first polypropylene (A) is a recycled polypropylene comprising at most 25.0% by weight of polyethylene based on the total weight of polypropylene (A);
and processing the polymer composition into an article.
